(19) United States
(12) Patent Application Publication
(10) Pub. No.: US 2008/0128937 A1
(43) Pub. Date: Jun. 5, 2008

(54) Foamed rotomolded polyethylene

(75) Inventor: XiaoChuan Wang, Calgary (CA)

Correspondence Address: Kenneth H. Johnson, P.O. Box 630708, Houston, TX, 77263, US

(73) Assignee: NOVA CHEMICALS(INTERNATIONAL) S.A.

(21) Appl. No.: 11/980,987

(22) Filed: Oct. 31, 2007

(30) Foreign Application Priority Data
Nov. 30, 2006 (CA) 2,569,935

(51) Int. Cl. C08F 210/02; B29C 65/02

(52) U.S. Cl. 264/41; 521/143; 521/144

(57) ABSTRACT

This invention relates to foamed structures prepared from a polyethylene having a high density, high melt index and narrow molecular weight distribution. In general, it is very difficult to prepare uniform foams from this particular type of polyethylene. We have discovered that the use of a nucleating agent mitigates this problem, particularly in a combined rotomolding/foaming process.

### FIELD OF THE INVENTION

This invention relates to foamed polyethylene structures and processes to prepare them. The structures are prepared from high density polyethylene resin and are preferably prepared in a rotomolding process.

### BACKGROUND OF THE INVENTION

Rotational molding or rotomolding has been broadly used to manufacture hollow articles or structures. It may be used to produce small and large containers (e.g. up to 20,000 gallons or larger). Polyethylene with a higher density or higher stiffness is advantageous to provide structural integrity for large parts. Polyethylene presently accounts for about 70-80% of the total resin volume used in the rotomolding industry.

Polyethylene foam is a well known item of commerce. Soft, or low density polyethylene foam is typically prepared from a polyethylene resin which is also characterized by having a low density. Soft or low foam densities can reduce overall part weight and resin material cost and impart good sound and thermal insulation properties in many applications. Two “families” of low density polyethylenes are generally suitable for this purpose, namely:

1) “high pressure” low density polyethylene (also referred to herein as “random” polyethylene) which is prepared by the homopolymerization of ethylene in a free radical initiated process at high pressures, thereby producing a polyethylene homopolymer with a randomly branched structure and a typical density of from less than 0.925 grams per cubic centimeter, (g/cc) and;
2) “linear” low density ethylene copolymer which is prepared by the copolymerization of ethylene with at least one other alpha olefin such as butene-1, hexene-1 or octene-1, thereby producing a polymer with a “linear” backbone and short chain branches which result from the comonomer. In general, the density of these “linear” copolymers decreases with increasing levels of comonomer. “Linear” polyethylene copolymers having a density of less than 0.925 g/cc, especially less than 0.915 g/cc, are useful for the preparation of soft foams.

It is well known that higher melt strength generally improves polymer foaming processes and foam quality. “High pressure” polyethylene may also be blended with “linear” polyethylene to prepare foamable compositions although this generally increases the overall cost. The structure of “high pressure” polyethylene typically contains some “long chain branching” which improves the melt strength of these blends and facilitates the foaming process. Thus, in general, the use of ethylene polymers having a higher degree of “long chain branching” facilitates the foaming process and improves foam quality. However, long chain branching may increase the zero-shear viscosity of a polyethylene and increase the powder sintering time, which may reduce the overall productivity.

Another two features of polyethylene architecture which can affect the foaming process are molecular weight and molecular weight distribution.

It will be appreciated by those skilled in the art that the melt strength of a polymer melt generally increases with increasing molecular weight. Optimum melt strength for foaming processes is generally observed when using comparatively high molecular weight polyethylene. However the use of polyethylene with higher molecular weight may reduce the powder sintering speed and hence the overall productivity of a rotomolding process.

The molecular weight distribution of the polyethylene can also influence the foaming process. “High pressure” polyethylene and (conventional) linear polyethylene both have comparatively broad molecular weight distributions which typically increase melt strength. In the case of conventional linear low density polyethylene, the molecular weight distribution and comonomer distribution are sufficiently broad that the polymer has two distinct melting peaks (as determined by differential scanning calometry, or DSC). More recently, “homogeneous” polyethylene copolymers having a narrow molecular weight distribution and comonomer distribution have been commercially available. For those skilled in the art, it will be appreciated that narrow molecular weight distribution improves processability in rotomolding but reduces melt strength. Rotational molding generally uses high processing temperatures and longer residence times. These conditions further decrease the melt strength of polyethylene. Thus, the use of a polyethylene with a narrow molecular weight distribution and high melt index makes it difficult to produce uniform foam (with no big voids), using the rotational molding process.

It is known that low foam densities can reduce overall part weight and resin material cost and impart good sound and thermal insulation properties in many applications.

Polyethylene foams may be produced with either a “physical” blowing agent or a “chemical” blowing agent.

Physical blowing agents are gases (which are preferably inert towards polyethylene) that are added to the polyethylene melt to cause expansion. Examples of physical blowing agents in commercial use include isobutane, pentanes, and (chlorinated) fluorocarbons. In contrast, “chemical” blowing agents are generally added to the polyethylene melt as solids. The high temperature of the foaming process causes the chemical blowing agent to decompose and release a gas which foams the melt.

The preparation of polyethylene foams from (homogeneous) linear low density polyethylene copolymer is disclosed in U.S. Pat. Nos. 5,932,659 and 6,531,520.

It is also known to prepare foamed polyethylene structures in a rotomolding process, as disclosed in U.S. Pat. Nos. 5,366,675 and 5,530,055. However, a problem still exists when attempting to use high melt index, narrow molecular weight distribution polyethylene resins to prepare uniform foams during a rotomolding process.

### SUMMARY OF THE INVENTION

We have now discovered a foamable polyethylene composition comprising:

I) a linear ethylene copolymer composition characterized by having:

a. a melt index, 12, as determined by ASTM D of from 3 to 8;

b. a density of from 0.930 to 0.960 g/cc; and

c. a molecular weight distribution of from 1.5 to 3.0;

### II) a foaming agent; and

### III) a foam nucleator.

In a preferred process, the foam is prepared in a rotomolding process wherein the polyethylene, a chemical blowing agent and a foam nucleator are subjected to rotomolding conditions:
i) adding said polyethylene copolymer, said chemical foaming agent and said foam nucleator to a mold;
ii) heating said polyethylene copolymer to a temperature of from 190 to 260° C. for sufficient time to cause said polyethylene copolymer to form a polyethylene melt;
iii) rotating said mold about 2 axes; and
iv) cooling said mold to solidify said polyethylene melt.

### DETAILED DESCRIPTION OF PREFERRED EMBODIMENTS

### A. Polyethylene

As noted above, polyethylene may be classified into two broad families, namely “random” (which is commercially prepared by initiation with free radicals under polymerization conditions that are characterized by the use of very high ethylene pressures) and “linear” (which is commercially prepared with a transition metal catalyst, such as a “Ziegler Natta” catalyst, or a “chromium” catalyst, or a single site catalyst or a “metallocene catalyst”).

Most “random” polyethylene which is commercially sold is a homopolymer of ethylene. This type of polyethylene is also known as “high pressure low density polyethylene” because the random polymer structure produces a lower polymer density. In contrast, most “linear” polyethylene which is commercially sold is copolymer of ethylene with at least one alpha olefin (especially butene, hexene or octene). The incorporation of a comonomer into linear polyethylene reduces the density of the resulting copolymer. For example, a “linear” ethylene homopolymer generally has a very high density (typically greater than 0.955 grams per cubic centimeter (g/cc)—but the incorporation of small amounts of comonomer results in the production of so-called “high density polyethylene” (or “hdpe”—typically, having densities greater than about 0.930 g/cc) and the incorporation of further comonomer produces so-called “linear low density polyethylene” (or “lldpe”—typically having a density of from about 0.905 g/cc to about 0.930 g/cc).

The family of “linear” polyethylenes may also be broken into two subgroups according to molecular weight distribution (and/or comonomer incorporation), namely “heterogeneous” polyethylene and “homogeneous” polyethylene. In general, “heterogeneous” polyethylene is a mixture of different fractions having different polymer structures. Some of these fractions generally have molecular weights and/or comonomer contents which are substantially different from the other fractions. For example, it will be recognized by those skilled in the art that linear polyethylene which is prepared with a conventional, heterogeneous Ziegler Natta catalyst typically contains three distinct polymer fractions, namely:

1) a “waxy” fraction which is characterized by having a very low molecular weight (less than 5000) and a high comonomer content i.e. a comonomer content of greater than 25 short chain branches or SCB per 1000 carbon atoms;
2) a “homopolymer” fraction which is characterized by having a very high molecular weight (greater than 80,000) and very low comonomer content (less than 4 SCB per 1000 carbon atoms); and
3) a third fraction having intermediate molecular weight and comonomer content.
These heterogeneous linear polymers typically have a molecular weight distribution (Mw/Mn) of greater than 3. In contrast, the polymer structure of “homogeneous” linear polyethylene is more uniform—i.e. the molecular weight (and comonomer content) of the polymer chains is more uniform (in comparison to “heterogeneous” polymers).

Those skilled in the art will recognize that molecular weight (and molecular weight distribution) may be determined by gel permeation chromatography (or GPC), as determined by ASTM D6474-99. However this test method is comparatively time consuming. Accordingly, a “melt index” or 12 test (ASTM D1238 at 190° C., using a 2.16 kg weight) is widely used by those skilled in the art to describe conveniently the flow properties of polyethylenes and as a quick/general indication of their molecular weight and molecular weight distribution. In general, melt index is inversely proportional to molecular weight (i.e. melt index decreases as molecular weight increases) and is often proportional to molecular weight distribution (i.e. for a given weight average molecular weight, Mw, the melt index increases as the molecular weight distribution, Mw/Mn, increases).

The polyethylenes used in the present invention are defined using the above described parameters. Specifically, the polyethylenes used in this invention must:
a) be a copolymer of ethylene with at least one alpha olefin;
b) have a melt index, 12, as determined by ASTM D1238 of from 3.0 to 8.0 (at a test temperature of 190° C., using a 2.16 kg weight);
c) have a density of from 0.930 to 0.960 grams per cubic centimeter; and
d) have a narrow molecular weight distribution—defined as Mw/Mn, or weight average molecular weight (Mw) divided by number average molecular weight (Mn)—as determined by ASTM D6474-99, of from 2.0 to 3.0.

It is permissible to use more than one polyethylene provided that the overall polyethylene composition which is being formed satisfies the melt index, density and molecular weight distribution criteria—i.e. the overall composition must all have a melt index of from 3.0 to 8.0; a density of from 0.930 to 0.960 g/cc and a molecular weight distribution (Mw/Mn) of from 2.0 to 3.0.

### B. Blowing Agent

The blowing agent used in this invention may either be a “physical” blowing agent or a chemical blowing agent.

Physical blowing agents are gases which are added to the polyethylene melt during the foaming operation. Examples of physical blowing agents include nitrogen, argon, carbon dioxide, fluorocarbons, water (steam), helium and hydrocarbons such as butanes or pentanes.

“Chemical” blowing agents are chemicals which decompose during the foaming operation to produce gas which forms the polyethylene composition. Examples of such chemical blowing include synthetic azo-, carbonate-, and hydrazide-based molecules, including azodicarbonamide, azodiisobutyronitrile, benzenesulfonhydrazide, 4,4-oxybenzene sulfonyl-semicarbazide, p-toluene sulfonyl semi-carbazide, barium azodicarboxylate, N,N′-dimethyl-N,N′-dinitrosoterephthalamide and trihydrazino triazine. Specific examples of these materials are azides such as Celogen OT (4,4′ oxybis (benzenesulfonylhydrazide); Hydrocerol BIF (preparations of carbonate compounds and polycarbonic acids); Celogen AZ (azodicarbonamide) and Celogen RA (p-toluenesulfonyl semicarbazide). Useful chemical blowing agents typically decompose at a temperature of 140° C. or above. Typically, decomposition of the blowing agent liberates gas, such as N₂, CO₂, and/or H₂O (steam). During the foaming process, the chemical blowing agent may be activated by heating the mixture to a temperature above its decomposition temperature. The amount of chemical blowing agent in the foamable polyethylene composition is chosen based on the foam density required. The preferred level of chemical blowing agent is in the range of 0.4-10 wt. %, especially in the range of 0.4-6 wt. %. Chemical blowing agents are (preferably) physically mixed with the polyethylene composition prior to the foaming process (as described in the examples).

### 1. Foam Nucleators (also Known as Foam Cell Nucleators)

We have observed that poor quality foams often result when using a high density polyethylene composition having a narrow molecular weight distribution, particularly for resins having a high melt index. This invention mitigates the problem with a foam nucleator. A foam nucleator (or combination of such nucleators) is employed to regulate cell formation and morphology. Inorganic and organic foam nucleators are known. Examples of inorganic foam nucleators include particulates such as calcium carbonate (especially precipitated calcium carbonate), clay, talc, silica and diatomaceous earth. These nucleators generally have a particle size of less than 10 microns. Commercially available talcs include Jetfil 700C (median diameter 1.5 microns), Mistron® Ultramix (median diameter 1.8 microns) and Mistron 554 (median diameter 3.3 microns). Talcs are preferred nucleators; especially talc having a particle size of from 0.1 to 4.0 microns. Precipitated calcium carbonate may also be employed. One commercially available grade of precipitated calcium carbonate has a median particle size of about 0.02 to 0.07 microns (Socal 312 from Solvay). Both coated and un-coated particles can be used. Nano-scale particles can also be used.

Other foam nucleators include organic nucleating agents. One example of an organic nucleating agent is a combination of an alkali metal salt of a polycarboxylic acid with a carbonate or bicarbonate. Some examples of alkali metal salts of a polycarboxylic acid include, but are not limited to, the monosodium salt of 2,3-dihydroxy-butanedioic acid (commonly referred to as sodium hydrogen tartrate), the monopotassium salt of butanedioic acid (commonly referred to as potassium hydrogen succinate), the trisodium and tripotassium salts of 2-hydroxy-1,2,3-propanetricarboxylic acid (commonly referred to as sodium and potassium citrate, respectively), and the disodium salt of ethanedioic acid (commonly referred to as sodium oxalate), or polycarboxylic acid such as 2-hydroxy-1,2,3-propanetricarboxylic acid.

The amount of nucleator used and the selection of a specific type depend upon the desired cell size, the selected blowing agent blend, and the desired foam density. The examples illustrate that foam density can be manipulated by changing the particle size of the nucleator (Inventive examples 2-5). The foam density may be reduced by using an inorganic nucleator with a smaller particle size. The level of nucleator in this disclosure can be in the range of about 0.01 to about 20 wt. % of the polyethylene resin composition, preferably in the range of 0.01-5 wt. %.

### 2. Optional Additives

Cell stabilizing agents may be optionally employed to help prevent or inhibit collapsing of the cell and hence improve foam quality. The cell stabilizing agents suitable for use in the present composition may include the partial esters of long-chain fatty acids with polyols described in U.S. Pat. No. 3,644,230 saturated higher alkyl amines, saturated higher fatty acid amides, complete esters of higher fatty acids and combinations thereof as described in U.S. Pat. No. 5,750,584. The partial esters of fatty acids that may be used as a cell stabilizing agent include the members of the generic class known as surface active agents or surfactants. A preferred class of surfactants includes a partial ester of a fatty acid having 12 to 18 carbon atoms and a polyol having three to six hydroxyl groups. More preferably, the partial ester of a long chain fatty acid with a polyol component of the stabilizing agent is glycerol monostearate, glycerol distearate or mixtures thereof. Routine experimentation with other cell stabilizing agents may be undertaken within the rotomolding process of this invention. The level of the cell stabilizing agents may be in the range of 0.05 and 10 wt. % by weight based on the weight of the polyethylene, preferably in the range of 0.05 to 3 wt. %.

If desired, fillers, colorants, light and heat stabilizers, anti-oxidants, acid scavengers, flame retardants, processing aids, extrusion aids and foaming additives may be used in making the foam. All the above ingredients and/or additives may be added via dry blending by using intensive mixers, or through melt compounding.

### 3. Foaming Processes

The foams of this invention may be prepared in any process which is conventionally used to prepare foamed polyethylene structures, such as those disclosed in U.S. Pat. No. 3,644,230 (extrusion process); U.S. Pat. No. 6,531,520 (compression molding); and U.S. Pat. No. 5,530,055 (rotomolding).

Rotomolding is well known to those skilled in the art and is in wide spread commercial use. In general, rotomolding is conducted by filling a closed mold (which is preferably made from aluminum or steel) with ground polyethylene. The mold is then heated while being rotated—hence the name “rotomolding”. The rotation is preferably done around at least two axes, thereby allowing the molten polyethylene to cover the mold surface. The mold is then cooled, then opened to remove the part.

It is highly preferred to prepare foamed rotomolded structures. The high melt index, narrow molecular weight distribution polyethylene resins used in the present invention are generally not well suited for the preparation of uniform foams, especially at low foam densities. However, these polyethylene compositions have been observed to perform well in rotomolding processes (when used in combination with a nucleator).

The invention can also be used in a so-called “one-shot” (one step) foaming process.

### EXAMPLES

The present invention will now be illustrated by the following non-limiting examples. Rotomolded parts having an external “skin” and a foam core were prepared in a two-stage rotomolding process. The skin layer was prepared in the first cycle, followed by a second cycle in which the foam core was prepared. A rotomolding machine (manufactured by Ferry Industries, model RS-160, and equipped with a cylindrical (pipe) mold) was used in all experiments.

575 grams of polyethylene having a density of 0.939 g/cc (+0.02 g/cc), a melt index, 12, of 5 g/10 minutes (+0.5 g/10 minutes) and a molecular weight distribution, Mw/Mn of about 2.4 (±0.3) was used to prepare the skin layer in the inventive and comparative experiments. The heating cycle conditions (time and temperature) and cooling cycle conditions are shown in Table 1.

After completion of the first cycle, the foamable composition (prepared from polyethylene, plus the foaming agent and nucleators shown in Table 1) were used to prepare the foam core.

In examples 2-6, the foam layer was prepared from the same polyethylene used in the skin layer.

In comparative example 1, the foam layer was prepared from an “easy to foam” polyethylene having a lower melt index (about 2), a higher density (about 0.944 g/cc) and a narrow molecular weight distribution, Mw/Mn, of about 2.4 (+0.3).

The finished skin-foam composite was cut and evaluated for its foam quality (digital and SEM images), average cell size determined by SEM, and apparent foam density determined by ASTM D1622.

### Example 1

### Comparative

As noted in Table 1, no nucleator was used but the foam quality was good—as evidenced by a foam density of 8.8 pounds per cubic foot and a general uniform foam appearance with an average cell size of about 544 microns. This shows that polyethylene having a narrow molecular weight distribution may be readily used to prepare uniform foam, provided that the melt index of the polyethylene is comparatively low.

### Example 2

### Comparison

In this example, the foam composition was prepared with resin powder and 2.9 wt. % of chemical blowing agent (Celogen OT). No cell nucleating agent was used. Foam quality was poor—with discontinuous areas of foam loosely connected to large voids being observed. This type of structure is not part of the present invention. However, it may be useful for large insulated tank structures having a very thick “skin”. That is, if the “skin” is thick enough to form a structural wall (i.e. a skin layer of from several millimetres to several centimetres thick), then the irregular foam core may not be required for structural integrity. In such structures, the presence of the large voids may improve the insulation factor of the overall structure.

### Example 3

### Invention

In this example, the foam composition was prepared with resin powder, 2.9 wt. % of chemical blowing agent (Celogen OT) and 0.5 wt. % of talc (Socal 312), which was supplied from Solvay Advanced Functional Minerals.

### Example 4

### Invention

In this example, the foam composition was prepared with resin powder, 2.9 wt. % of chemical blowing agent (Celogen OT) and 0.5 wt. % of talc (Jetfil 700C), which was supplied from Luzenac America.

### Example 5

### Invention

In this example, the foam composition was prepared with resin powder, 2.9 wt. % of chemical blowing agent (Celogen OT) and 0.5 wt. % of talc (Mistron Ultramix), which was supplied from Luzenac America.

### Example 6

### Invention

In this example, the foam composition was prepared with resin powder, 2.9 wt. % of chemical blowing agent (Celogen OT) and 0.5 wt. % of Mistron 554 which was supplied from Luzenac America.

TABLE 1
Examples of Skin-Foam Composite Formulation, Rotational Molding Conditions and Test Results

| | Comparison | Comparison | Invention | Invention | Invention | Invention |
|---|---|---|---|---|---|---|
| | (Example 1) | (Example 2) | (Example 3) | (Example 4) | (Example 5) | (Example 6) |
| Skin molding condition | | | | | | |
| Melt Index (I₂), g/10 min. | 5 | 5 | 5 | 5 | 5 | 5 |
| Charge weight (g) | 575 | 575 | 575 | 575 | 575 | 575 |
| Oven temperature (° F.) | 560 | 560 | 560 | 560 | 560 | 560 |
| Oven time (minute) | 7.5 | 7.5 | 7.5 | 7.5 | 7.5 | 7.5 |
| Cooling method | Forced air | Forced air | Forced air | Forced air | Forced air | Forced air |
| Cooling time (minute) | 19.5 | 19.5 | 19.5 | 19.5 | 19.5 | 19.5 |
| Foam core formulation and | | | | | | |
| molding condition | | | | | | |
| Melt Index (I2), g/10 min. | 2 | 5 | 5 | 5 | 5 | 5 |
| Chemical blowing agent | Celogen OT | Celogen OT | Celogen OT | Celogen OT | Celogen OT | Celogen OT |
| Chemical blowing agent (wt. %) | 2.9 | 2.9 | 2.9 | 2.9 | 2.9 | 2.9 |
| Cell nucleating agent | None | None | Socal 312 | Jetfil 700C | Mistron Ultramix | Mistron 554 |
| Median particle size of cell | — | — | 0.02-0.07 | 1.5 | 1.8 | 3.3 |
| nucleating agent (microns) | | | | | | |
| Cell nucleating agent (wt. %) | — | — | 0.5 | 0.5 | 0.5 | 0.5 |
| Total charge weight (g) | 250 | 250 | 250 | 250 | 250 | 250 |
| Oven temperature (° F.) | 470 | 470 | 470 | 470 | 470 | 470 |
| Oven time (minute) | 19 | 18 | 18 | 18 | 18 | 18 |
| Cooling method | Forced air | Forced air | Forced air | Forced air | Forced air | Forced air |
| Cooling Time (minute) | 32 | 31 | 31 | 31 | 31 | 31 |
| Test Results | | | | | | |
| Average foam cell size (microns) | 544 | 835 | 1154 | 822 | 485 | 563 |
| Foam quality (see images) | Uniform foam | big voids | Uniform foam | Uniform foam | Uniform foam | Uniform foam |
| Foam density (lb/ft³, ASTM D1622) | 8.8 | big voids, | 7.6 | 10.7 | 13.2 | 13.2 |
| | | not tested | | | | |

What is claimed is:

1. A foamable polyethylene composition comprising:
I) a linear ethylene copolymer composition characterized by having:
a) a melt index, 12, as determined by ASTM D of from 3 to 8;
b) a density of from 0.930 to 0.960 g/cc; and
c) a molecular weight distribution of from 1.5 to 3.0;
II) a foaming agent; and
III) a foam nucleator.

2. The composition of claim 1 wherein said ethylene copolymer composition comprises at least one copolymer of ethylene with at least one comonomer selected from butene-1, hexene-1 and octene-1.

3. The composition of claim 1 wherein said foaming agent is a chemical foaming agent is an azide.

4. The composition of claim 1 wherein said foam nucleator is a particulate selected from the group consisting of talc and calcium carbonate.

5. A process to prepare a foamed polyethylene structure comprising:
Step I) mixing a chemical foaming agent and a foam nucleator into a linear polyethylene copolymer composition, wherein said linear polyethylene copolymer composition is characterized by having:
a) a melt index, 12, as determined by ASTM D of from 3 to 8;
b) a density of from 0.930 to 0.960 g/cc;
c) a molecular weight distribution of from 1.5 to 3.0; and
Step II) activating said foaming agent.

6. A process to prepare a foamed, rotomolded part comprising:
Step I) mixing a chemical foaming agent and a foam nucleator into at least one linear polyethylene copolymer, wherein said linear polyethylene copolymer is characterized by having:
a) a melt index, 12, as determined by ASTM D of from 3 to 8;
b) a density of from 0.930 to 0.960 g/cc;
c) a molecular weight distribution of from 1.5 to 3.0; and
Step II) subjecting said copolymer to rotomolding conditions.

7. The process of claim 6 wherein said rotomolding conditions consist of:
i) adding said polyethylene copolymer, said chemical foaming agent and said foam nucleator to a mold;
ii) heating said polyethylene copolymer to a temperature of from 190 to 260° C. for sufficient time to cause said polyethylene copolymer to form a polyethylene melt;
iii) rotating said mold about 2 axes; and
iv) cooling said mold to solidify said polyethylene melt.
